(19) United States
(12) Patent Application Publication
(10) Pub. No.: US 2005/0257814 A1
(43) Pub. Date: Nov. 24, 2005

(54) Apparatus for removing a strip of coating material from an imaging drum such as used in xerography

(75) Inventors: Steven D. Bush, Red Creek, NY (US); Joseph A. Tumminelli, Rochester, NY (US); Magda M. Alvarez-Estrada, Rochester, NY (US); Mark E. Klino, Palmyra, NY (US); Dante M. Pietrantoni, Rochester, NY (US); Helen R. Cherniack, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/852,440

(22) Filed: May 24, 2004

(51) Int. Cl. B08B 3/04

(52) U.S. Cl. 134/148; 134/166 R; 134/153; 134/198

(57) ABSTRACT

An apparatus for removing a strip of coating material from one end of a drum, such as a photoreceptor drum used in xerography. A circular slit is formed in a resilient member, such as of closed-cell polyethylene foam. The end of the drum is rotated in the slit in the presence of a solvent, to remove the coating from the drum. A funnel-shaped shield encloses and extends upward from the circular slit, to retain the solvent and prevent splashing of solvent and other materials on neighboring hardware.

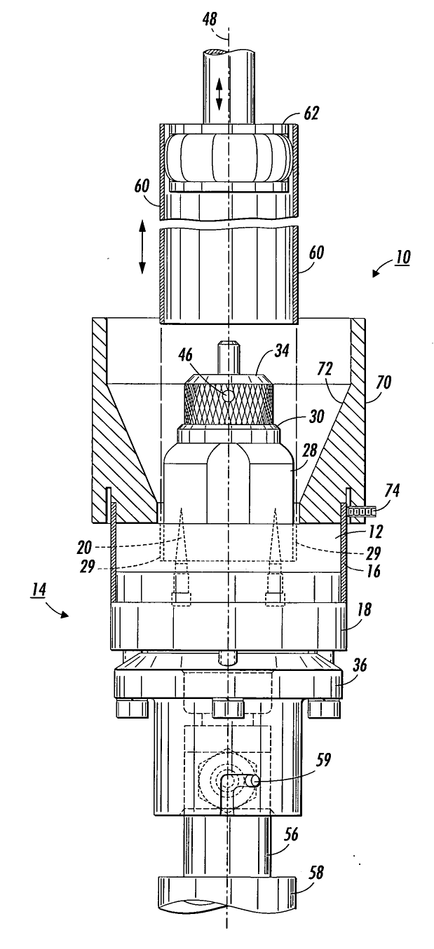

The following US patent is incorporated by reference for the teachings therein: U.S. Pat. No. 6,461,442 B1.

### TECHNICAL FIELD

This invention relates in general to electrostatography or xerography and, more specifically, to a system for removing coating material from an end of a drum, such as a photoreceptor drum used in xerography.

### BACKGROUND

In electrostatography, and particularly in electrophotography or xerography, coated substrates such as cylindrical photoreceptor drums (photoreceptors) are commonly used in copier, duplicator, facsimile and multifunctional machines. Photoreceptor embodiments include at least one coating of photosensitive material typically comprising film forming polymer material, which can be formed on the photoreceptor by known techniques such as immersion or dip coating.

The ends of a coated photoreceptor are often used to engage members such as spacers, rollers, seals, developer housings, grounding devices and the like. If these members ride on a coated area of the drum, the coating material is rubbed off and the resulting debris can contaminate various components in the machine such as the cleaning system and any optical exposure systems employed in the machine. Also, the coating can interfere with devices that are designed to electrically ground the drum by contacting the outer surface at one end of the drum. Moreover, if the coating thickness is irregular because of poor removal techniques, spacing devices riding on the outside surface of the drum cannot maintain precise spacing between the drum and critical subsystems such as charging, developing, cleaning or other subsystems. Further, if coating material is present in the interior of the drums adjacent the ends of the drum, insertion of supporting end caps may be prevented or hindered. Also, uneven coating deposits in the interior of the drums can cause misalignment of the end caps which, in turn, can cause the drum to wobble during image cycling. The uncoated region at the end of the drum is also necessary to prevent delaminating or cracking of the organic layers at the base of the photoreceptor when the photoreceptor is cycled in an imaging machine. Thus, specified areas at both the outer and inner peripheral ends of a photoreceptor must be free of coating material.

One end of the drum may be maintained free of deposited coating by not immersing a small portion of the upper end of the drum into the coating solution. More specifically, the upper end of the photoreceptor drum can be kept free of coating material by orienting the drum vertically and dipping the drum into a bath of coating material to a predetermined depth which avoids complete immersion of the drum. However, the coating formed over the lower end of the photoreceptor must still be removed or prevented from depositing during dip coating. There are many methods and techniques for accomplishing this. One technique for preventing coatings from depositing is by masking the lower end of the drum prior to dip coating. This technique is time consuming and requires excessive handling. Systems for removing deposited coatings include, for example, laser ablation, mechanically wiping the lower end with blades or brushes and/or by applying solvents to it.

One coating removal method involves using a wiper blade or brush to wipe off the bottom portion of each drum with solvent, to remove the organic polymer films in the intended uncoated region. One technique involves lowering the drum onto a sponge spindle to steady the end of the drum and thereafter, wipe the bottom outside edge of the drum with a flexible wiper blade. This blade wiping system utilizes tapered elastomeric rollers. Each roller is mounted on one end of an arm which has a center pivot point. The other end of the arm carries a wiping blade. As a drum is lowered, the end of the drum engages the tapered end of each roller causing it to offset and move the arm which, in turn, causes the blade to wipe the coating material from the outer surface of one end of the lowered photoreceptor. This method performs well with photoreceptors which require a large coating-free circumferential strip having, for example, a width of 9 millimeters.

The present embodiment is directed to an improved apparatus for removing the strip of coating material from an end of a photoreceptor drum.

### PRIOR ART

U.S. Pat. No. 6,461,442, incorporated by reference above, discloses a method and apparatus for removing a strip of coating material from a photoreceptor drum.

### SUMMARY

There is provided an apparatus for removing a coating material from a hollow imaging drum, the drum having a first end, an outside surface, an inside surface and coating material on at least one of the inside surface and the outside surface at the first end. A resilient member contacts the coating material on at least the outside surface at the first end of the drum with resilient foam material, the resilient member defining a substantially horizontal top surface and a circular slit perpendicular to the substantially horizontal top surface. Relative movement is produced between the foam material and the drum to simultaneously wipe both the inside surface and the outside surface of the first end of the drum with the foam material. A shield, defining an interior surface, extends over the top surface of the resilient member and encloses an area around the circular slit.

### BRIEF DESCRIPTION OF THE DRAWING

The FIGURE is a schematic side view in elevation of a cleaning assembly for a photoreceptor drum.

### DETAILED DESCRIPTION

A more fully detailed description of certain aspects of the embodiment is available in the patent incorporated by reference above; in the present description, the cleaning assembly is described in sufficient detail to enable aspects of the claims.

Referring to the FIGURE, a cleaning assembly 10 is shown comprising a resilient member in the form of cleaning foam 12 retained in a housing 14 comprising a bowl ring 16 removably mounted on a base 18. Secured to base 18 is at least one threaded spike 20 which penetrates cleaning foam 12 and prevents it from turning during cleaning. Any suitable housing 14 may be utilized to retain the cleaning foam 12 during the coating removal operation. The housing may be solid, foraminous, notched, and the like. The housing should be sufficiently rigid to retain the foam in position during the cleaning operation. Generally, the cleaning foam 12 is sufficiently compressed when confined within the housing 14 to achieve a friction fit which retains the foam in the housing during the coating removal cycle. Alternatively, retaining members may be used to prevent slippage. Typical retaining members include, for example, pins, spikes, knurled interior surfaces of the housing (not shown) and the like. A resilient guide spindle 28 is positioned around shaft 24 and on top of cleaning foam 12.

In practical applications, cleaning foam 12 can comprise a closed-cell foam such as of polyethylene, with an average cell diameter of between about 1 millimeter and about 3 millimeters. In another possible embodiment, the closed-cell foam can be replaced with an arrangement of fibers or brushes.

Cleaning foam 12 defines a circular slit 29 having a diameter equal to or slightly smaller than the largest diameter of resilient guide spindle 28. The circular slit 29 is perpendicular to a substantially horizontal top surface defined by cleaning foam 12. The circular slit can be said to define two circular walls, one facing inward and one facing outward, each of which contacts an inner or outer surface of a drum inserted therein, as will be described below. The circular slit 29 is dimensioned to remove a strip of coating material from at least the outside surface of the first end of the drum, the strip having a width between about 3.5 millimeters and about 9 millimeters. The circular slit 29 is coaxial with the axis 48 around which parts of the assembly 10, or drum 60, are rotatable, as will be described below.

In this embodiment, washer 30 carries a pin (not shown) which becomes imbedded into resilient guide spindle 28 when threaded screw cap 34 is screwed onto the upper threaded end of hollow shaft 24. Threaded screw cap 34 also presses resilient guide spindle 28 against cleaning foam 12 to ensure retention of cleaning foam 12 within housing 14 during the cleaning operation. Screw cap 34 contains at least one exit opening 46 to allow solvent to exit screw cap 34 and flow downwardly over guide foam 28 onto cleaning foam 12. As shown in the particular embodiment, spindle 28, screw cap 34, and any other hardware within the area defined by circular slit 29 above the substantially horizontal surface of foam 12 can be considered a “central assembly,” as will be described below.

Also shown in the FIGURE is a drive shaft 56 driven by a drive device 58. Drive shaft 56 has a pin 59 which aids in connecting shaft 56 to flange 36. Any suitable means for causing the desired motion of drive device 58 may be utilized. Typical means (not shown) for causing motion of drive device 58 include, for example, a gear box, a smart motor, an air driven motor, and the like. When activated, drive device 58 causes cleaning assembly 10 to rotate around axis 48.

In operation, a coated photoreceptor drum 60 carried by reciprocable chuck 62 is advanced downwardly over resilient guide spindle 28 and into circular slit 29 for simultaneous removal of coating material from a circumferential strip on the inside surface and outside surface of the lower end of drum 60. Upon completion of coating removal, reciprocable chuck 62 is retracted (i.e., moved upwards as shown in the FIGURE) to remove drum 60 from cleaning assembly 10.

In the embodiment shown in the FIGURE, the cleaning assembly formed by slit 29 in cleaning foam 12 is rotated about its axis by drive device 58 to achieve relative movement and scrubbing contact between the surfaces of foam 12 in slit 29 and the adjacent interior and exterior surfaces of drum 60. Alternatively, the cleaning assembly may be stationary and the chuck and drum may be rotated or both the cleaning assembly and the chuck and drum may be rotated in opposite directions to achieve relative motion between the contacting foam material and the drum surface. This relative movement between the foam material and the drum simultaneously removes coating material from the inside surface and the outside surface of the lower end of the drum.

With particular reference to the present embodiment, there is further provided a shield, here in the form of a largely cylindrical cowling 70 (shown in cross-section), which is supported by bowl ring 16 and surrounds spindle 28 and screw cap 34. As shown in the FIGURE, the cowling 70 encloses an area at the top surface of the foam material 12 around the circular slit 29 and extends above the top of screw cap 34 or any “central assembly” hardware associated with the cleaning assembly 10. In absolute terms, the cowling 70 extends at least one-half inch, and in a common application one inch or more, over a top surface of the resilient member such as cleaning foam 12. The cowling 70 can be held in place on bowl ring 16 by a screw such as 74. The purpose of cowling 70 is to shield any neighboring hardware (not shown) from splashing (of solvent, particles of removed coating, or any other material) that may occur by the entry, motion, or removal of a drum 60 relative to assembly 10.

The internal surface 72 of cowling 70 is shaped to direct any splashed material hitting it toward the slits 29, for removal through the drainage system within assembly 10. In particular, as shown in the embodiment, the internal surface 72 is sloped to form a funnel which decreases in internal diameter moving downward. The lower portion of the internal surface terminates, as shown, at the top of circular slit 29. The cowling 70 can thus be used to allow draining of solvent and/or waste material away from the drum 60 in a controlled manner with a minimum of splashing.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. An apparatus for removing a coating material from a hollow imaging drum, the drum having a first end, an outside surface, an inside surface and coating material on at least one of the inside surface and the outside surface at the first end, comprising
a resilient member for contacting the coating material on at least the outside surface at the first end of the drum with resilient foam material, the resilient member defining a substantially horizontal top surface and a circular slit perpendicular to the substantially horizontal top surface;
means for producing relative movement between the foam material and the drum to simultaneously wipe both the inside surface and the outside surface of the first end of the drum with the foam material and solvent material; and
a shield, defining an interior surface, extending over the top surface of the resilient member and enclosing an area around the circular slit.

2. The apparatus of claim 1, the interior surface of the shield defining a slope substantially directed toward the circular slit.

3. The apparatus of claim 1, further comprising
a central assembly disposed within an area defined by the circular slit, the shield extending above the central assembly.

4. The apparatus of claim 1, the shield extending at least one-half inch over the top surface of the resilient member.

5. The apparatus of claim 1, the shield extending at least one inch over the top surface of the resilient member.

6. The apparatus of claim 1, further comprising
means for rotating the resilient member while maintaining the drum stationary to produce relative movement between the resilient member and the drum.

7. The apparatus of claim 1, wherein the foam material comprises closed cell foam.

8. The apparatus of claim 1, wherein the foam material comprises polyethylene.

9. The apparatus of claim 1, wherein the foam material comprises cells having an average cell diameter of between about 1 millimeter and about 3 millimeters.

10. The apparatus of claim 1, wherein the circular slit is dimensioned to remove a strip of coating material from at least the outside surface of the first end of the drum, the strip having a width between about 3.5 millimeters and about 9 millimeters.

11. The apparatus of claim 1, wherein the foam material is compressed against the drum while simultaneously wiping both an inside surface and the outside surface of the first end of the drum.

12. The apparatus of claim 1, further comprising
means for flowing liquid solvent to the foam material where the foam material contacts the first end of the drum.
